(19) United States
(12) Patent Application Publication
(10) Pub. No.: US 2006/0064194 A1
(43) Pub. Date: Mar. 23, 2006

(54) Methods and systems for determining lithography overlay offsets

(75) Inventor: Yung-Yao Lee, Tainan County (TW)

Correspondence Address: BIRCH STEWART KOLASCH & BIRCH, PO BOX 747, FALLS CHURCH, VA, 22040-0747, US

(73) Assignee: ProMOS Technologies Inc.

(21) Appl. No.: 10/974,715

(22) Filed: Oct. 28, 2004

(30) Foreign Application Priority Data
Sep. 21, 2004 (TW) 093128583

(51) Int. Cl. G06F 19/00

(52) U.S. Cl. 700/121; 700/117; 700/108

(57) ABSTRACT

A system for determining lithography overlay offsets is described. The system comprises a first database, a second database, and a controller. The first database stores operation records of lots processed consecutively by an exposure tool, wherein each lot corresponds to a layer of a product, and the operation records pertain to a subsequent lot Lₖ and a previous lot Lₖ₋₁ corresponding to products A and B, respectively. The second database stores overlay information of lots corresponding to the products A and B, comprising overlay information D_{A,X} and D_{B,Y} corresponding to X^{th} and y^{th} records of products A and B. The controller determines the overlay offset corresponding to lot Lₖ according to the overlay information D_{A,X} and D_{B,Y}.

### BACKGROUND

The invention relates in general to semiconductor lithography, and more specifically to methods and systems of determining overlay offsets to compensate overlay errors in semiconductor lithography processes.

An important feature in semiconductor lithography is overlay, or image placement of one lithographic level relative to another. Overlay errors of one level relative to the prior level thereof are typically broken down into systematic and non-systematic components. The systematic components are typically, for example, X and Y translation, lithographic field X and Y magnification, rotation, and skew. These systematic components are used to generate overlay offsets transferred to the aligner to achieve proper overlay.

Conventionally, there are numerous approaches to achieve good overlay. For loose overlay specifications relative to aligner and process capability, fixed overlay offsets can be used with reasonable success. As specifications tighten, it is necessary to periodically update overlay offsets.

One method of updating offsets is to couple a database with a software data filtering means and averaging algorithm to automatically adjust offsets. Due to either process/aligner variability or aligner shifts, an average of past offsets, no matter how well sorted, is not essentially the optimum predictor of what a current lot requires for substantial overlay accuracy. Additionally, this method assumes homogeneity between the wafers on which the overlay error is measured, and the subsequent wafers are patterned by the exposure tool. As wafer processing techniques change from lot-to-lot control to wafer-to-wafer control, this assumption becomes less valid. A particular wafer, lot, or subset of wafers in a lot may not have identical overlay characteristics with respect to the underlying layers.

Another method for updating offsets is to execute a test run using a test wafer, and to measure overlay errors of the processed test wafer to determine an overlay offset for a subsequent run. This method can typically obtain a more accurate prediction of corresponding overlay offset. Unfortunately, execution of test runs incurs additional cost.

### SUMMARY

Systems and methods of determining lithography overlay offsets are provided. By determining lithography overlay offsets, some embodiments of systems and methods perform lithography processes achieving higher overlay accuracy.

According to one embodiment of the invention, a system of determining lithography overlay offsets is provided. The system comprises a first database, a second database, and a controller. The first database stores operation records of lots processed consecutively by an exposure tool, wherein each lot corresponds to a layer of a product, and the operation records pertain to a subsequent lot and a previous lot corresponding to products A and B, respectively. The second database stores overlay information of lots corresponding to the products A and B, comprising overlay information of current lots and that corresponding to processed lots of products A and B. The controller determines the overlay offsets corresponding to the subsequent lot according to the overlay information.

A method of performing a lithography process is also provided. Operation records of lots processed consecutively by an exposure tool are provided, wherein each lot corresponds to a layer of a product, and the operation records pertain to a subsequent lot and a previous lot corresponding to products A and B, respectively. Overlay information of lots corresponding to the products A and B is also provided, which comprises overlay information corresponding to current lots and processed lots of products A and B. The overlay offsets corresponding to the subsequent lot are determined according to the overlay information corresponding to processed lots of products A and B.

The above-mentioned method may take the form of program code embodied in a tangible media. When the program code is loaded into and executed by a machine, the machine becomes an apparatus for practicing the invention.

These disclosed systems and methods are capable of determine lithography overlay offsets. By determining lithography overlay offsets, some embodiments of systems and methods perform lithography processes achieving higher overlay accuracy. Additionally, the overlay offsets are determined according to previous overlay offsets without using a test wafer.

### DESCRIPTION OF THE DRAWINGS

The invention can be more fully understood by reading the subsequent detailed description and examples with references made to the accompanying drawings, wherein:

FIG. 1 is a schematic view of an embodiment of a lithography system;

FIG. 2 is a schematic view of an embodiment of consecutive operations of an exposure tool;

FIG. 3 illustrates a schematic view showing the arrangement of overlay information in an embodiment of a database;

FIG. 4 illustrates a flowchart of an embodiment of lithography method;

FIG. 5 illustrates overlay information used in FIG. 4; and

FIG. 6 illustrates a schematic view showing correlation between overlay offset and process time.

### DETAILED DESCRIPTION

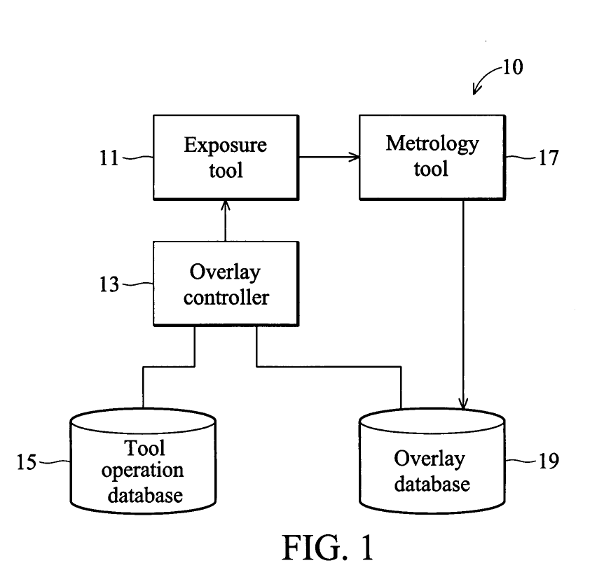

Embodiments of the invention will now be described with reference to FIGS. 1 to 6, which in general relate to a lithography system.

FIG. 1 is a schematic view of an embodiment of a lithography system. The lithography system 10 capable of performing consecutive lithography processes comprises an exposure tool 11, an overlay controller 13, a tool operation database 15, a metrology tool 17, and an overlay database 19.

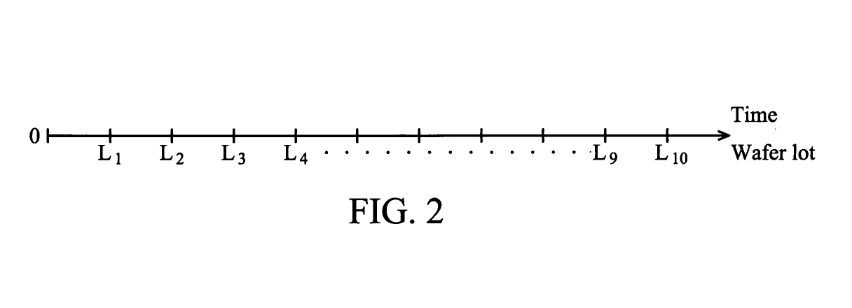

Exposure tool 11 consecutively processes wafer lots, wherein each wafer lot corresponds to a particular product layer. Referring to FIG. 2, exposure tool 11 sequentially processes wafer lots L₁˜L₁₀, wherein wafer lots L₁˜L₉ have been processed, and wafer lot L₁₀ is scheduled to be processed at a preset time. Operation records of wafer lots L₁˜L₉ are sequentially stored in tool operation database 15 according to the time when they are processed. The operation record comprises information pertaining to the processed wafer lot, such as wafer lot ID, process sequential number, process time, and corresponding product ID and layer ID.

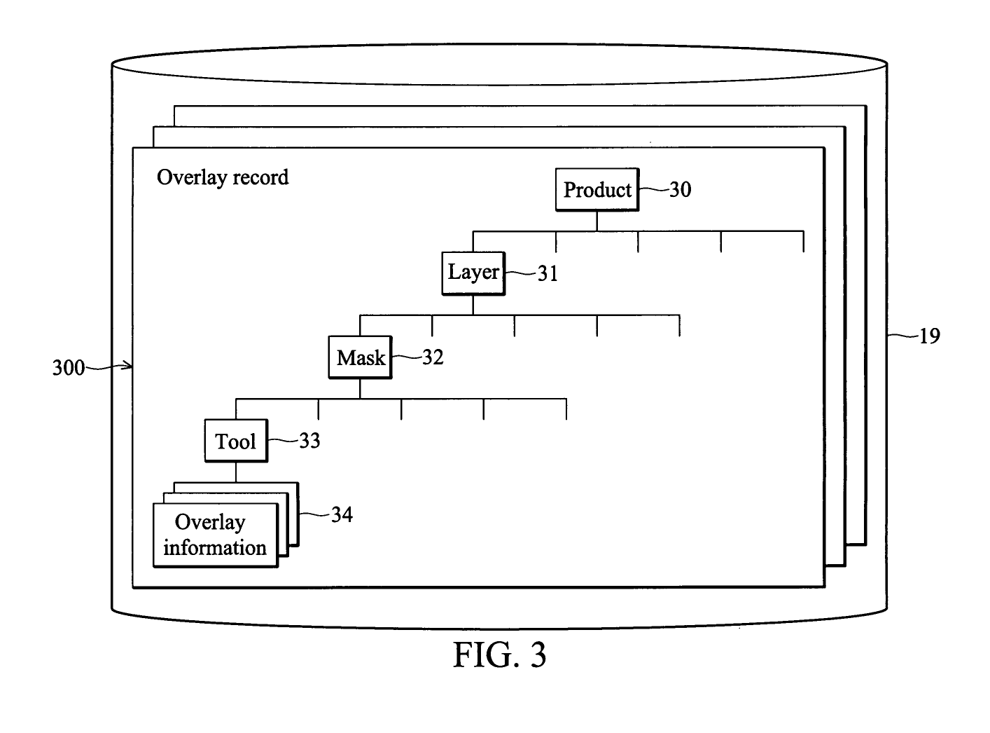

Metrology tool 17 measures overlay errors on wafer lots processed by the exposure tool 11, and stores the measurement in the overlay database 19. The overlay database 19 stores overlay information including overlay offsets of wafer lots corresponding to different layers of different products. Additionally, the overlay database 19 also stores other information pertaining to processed wafer lots, such as process time, product ID, layer ID, mask information, and exposure tool information. The overlay database 19 comprises overlay information arranged in a multi-level hierarchical order, or the structure as shown in FIG. 3. Referring to FIG. 3, overlay record 300 comprises overlay information 34 corresponding to a plurality of wafer lots pertaining to a particular product. In the tree-structure shown in FIG. 3, product ID 30 serves as the root of overlay record 300, layer ID 31 is a child node thereof, a mask ID 32 is a child node of the node of layer ID 31, and exposure tool ID 33 is again a child node of the node of mask ID 32. The overlay information can be stored in another structure to meet special needs, and is not limited to the described tree-structure herein.

Overlay controller 13 determines the overlay offset of the exposure tool 11 to process the subsequent wafer lot L₁₀ according to the overlay information stored in the overlay database 19.

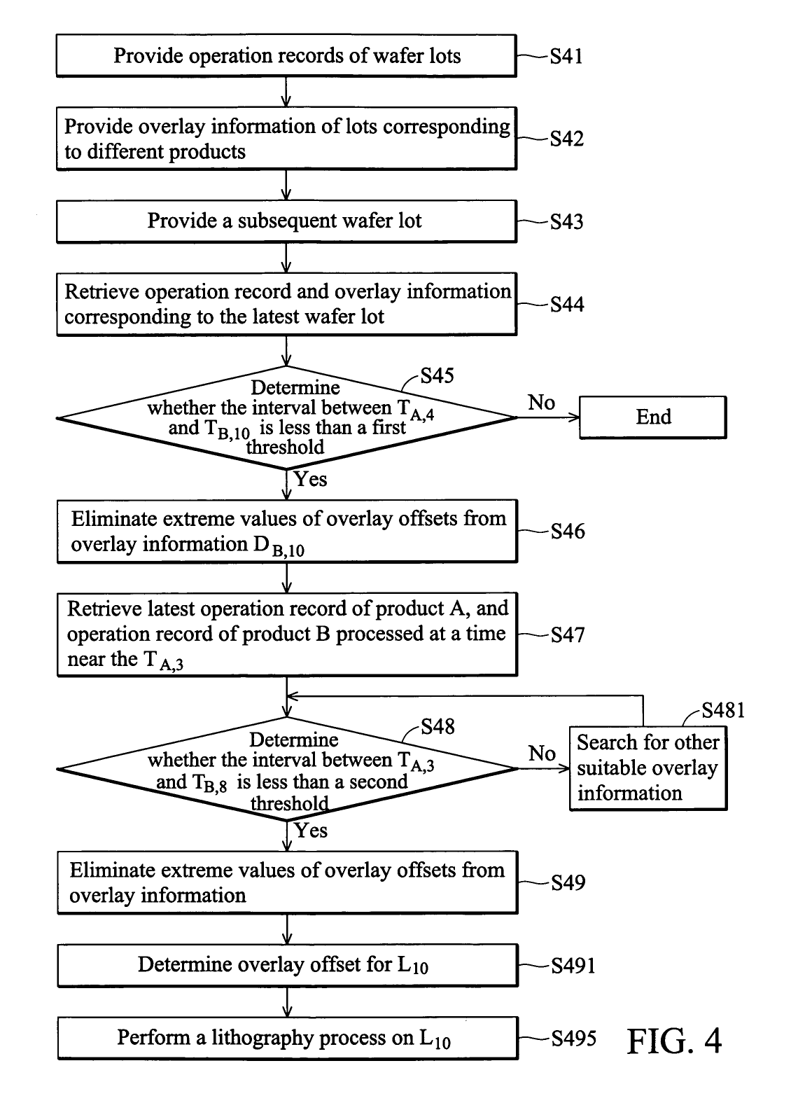

FIG. 4 is a flowchart of lithography method. The lithography method as shown in FIG. 4 can be implemented in a system shown in FIG. 1, determining overlay offsets and performing lithography processes in the lithography system described above and shown in FIG. 1.

Referring to FIG. 4, operation records of wafer lots processed consecutively by an exposure tool are provided (step S41). The exposure tool, for example, a stepper, is capable of processing wafer lots consecutively, wherein each wafer lot corresponds to a particular layer of a product. The wafer lots can be processed in a sequence as shown in FIG. 2. Referring to FIG. 2, the exposure tool processes wafer lots L₁˜L₁₀ sequentially, wherein wafer lots L₁˜L₉ have been processed, and wafer lot L₁₀ is scheduled to be process at a preset time. Operation records of wafer lots L₁˜L₉ are stored in a tool operation database sequentially according to the time when they are processed. The operation information comprises information pertaining to the processed wafer lot, such as wafer lot ID, process sequential number, process time, product ID, and layer ID.

Overlay information of lots corresponding to different products is also provided (step S42). The overlay information can be stored in an overlay database. The overlay database stores overlay information that includes overlay offsets of wafer lots corresponding to different layers of different products. Additionally, the overlay database further stores other information pertaining to processed wafer lots, such as process time, product ID, layer ID, mask information, and exposure tool information. The overlay database comprises overlay information arranged in a tree-structure as shown in FIG. 3. Referring to FIG. 3, overlay record 300 comprises overlay information 34 corresponding to a plurality of wafer lots pertaining to a particular product. In the tree-structure shown in FIG. 3, product ID 30 serves as the root of overlay record 300, layer ID 31 is a child node thereof, a mask ID 32 is a child node of the node of layer ID 31, and exposure tool ID 33 is again a child node of the node of mask ID 32. The overlay information can be stored in another structure to meet requirements, and is not limited to the described tree-structure.

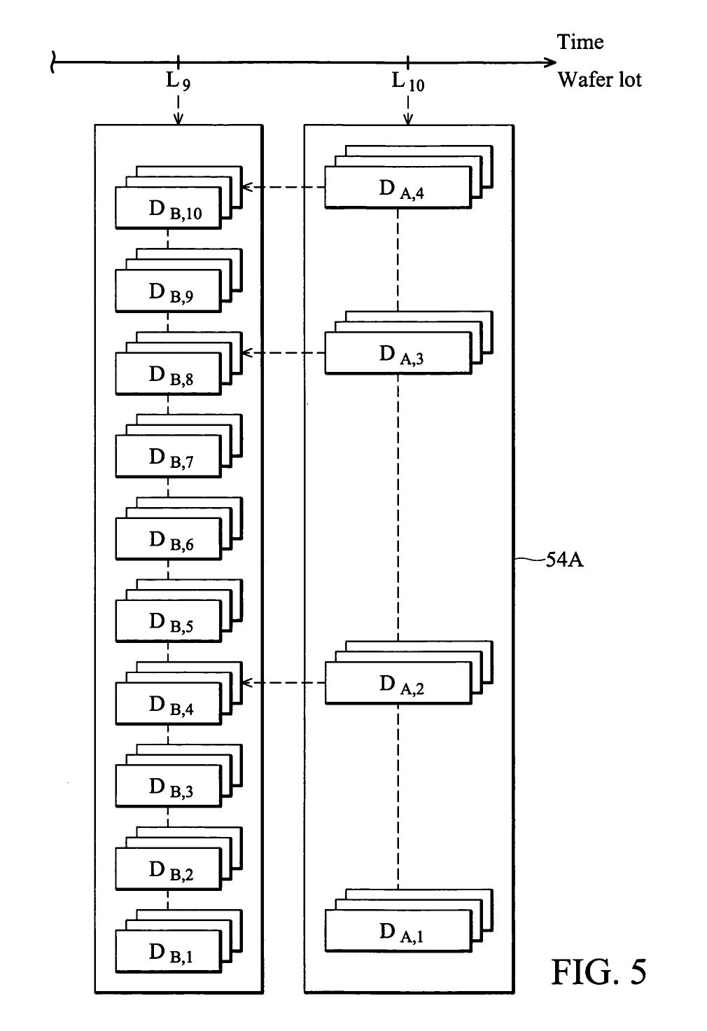

A current wafer lot, for example, wafer lot L₁₀, is provided (step S43). As shown in FIG. 5, wafer lot L₁₀ is the 10^{th} lot in the operation record of the exposure tool, wherein the wafer lot L₁₀ corresponds to the 5^{th} layer of product A, and its overlay information is stored as 4^{th} overlay information (denoted as D_{A,4}) in overlay record 54A of product A. Additionally, wafer lot L₁₀ is scheduled to be processed at time T_{A,4}.

The overlay offset corresponding to wafer lot L₁₀ is then determined. According to the operation record of the exposure tool, an operation record and overlay information corresponding to latest wafer lot processed by the exposure are retrieved (step S44). Referring to FIG. 3, the latest wafer lot processed by the exposure tool is wafer lot L₉. Wafer lot L₉ corresponds to the 9^{th} operation record of the exposure tool, pertaining to the 7^{th} layer of product B, and is exposed using a mask B at time T_{B,10}. The overlay information corresponds to wafer lot L₉ is stored as 10^{th} entry in the overlay record of product B (denoted as D_{B,10}). As seen in FIG. 5, the exposure tool processes wafer lots corresponding-to product B at a frequency higher than wafer lots corresponding to product A.

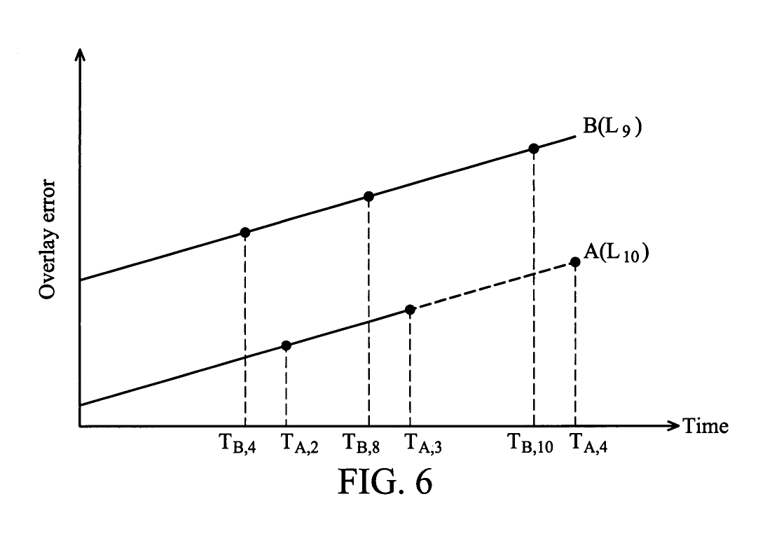

In step S45, it is determined whether the interval between T_{A,4} and T_{B,10} is less than a first threshold. The first threshold can be determined according to conditions of the exposure tool. For example, five-days is determined as the first threshold. Within the first threshold, the overlay offset of the exposure tool is considered to be substantially close. FIG. 6 illustrates a schematic view of process time of wafer lots corresponding to products A and B. When the time interval between T_{A,4} and T_{B,10} exceeds the first threshold, the overlay offset of the exposure tool may be substantially different at T_{A,4} and T_{B,10}. In order to obtain a more accurate prediction of overlay offset at T_{A,4}, a test run is performed rather than using the out-of-date D_{B,10} to do the prediction.

The overlay information of a particular wafer lot typically comprises overlay offsets for a plurality of process runs. In order to obtain better prediction of overlay offset at T_{A,4}, overlay offsets for a plurality of process runs are checked to eliminate extreme values of overlay offsets from overlay information D_{B,10} (step S46). The checking process can be performed using 3-sigma method or other statistical methods.

In step S47, the latest operation record of product A is retrieved from the operation database. In some embodiments, the latest operation record of product A is D_{A,3} corresponding to a wafer lot processed at T_{A,3}. An operation record of product B corresponding to a wafer lot processed at a time near the T_{A,3} is retrieved. In some embodiments, D_{B,8} is processed at time T_{B,8}, a process time at most proximity to T_{A,3}.

In step S48, it is determined whether the interval between T_{A,3} and T_{B,8} is less than a second threshold. The second threshold can be determined according to conditions of the exposure tool. Within the second threshold, the overlay offset of the exposure tool is considered to be substantially close. FIG. 6 illustrates a schematic view of process time of wafer lots corresponding to products A and B. When the time interval between T_{A,3} and T_{B,8} exceeds the second threshold, the overlay offset of the exposure tool may be substantially different at T_{A,3} and T_{B,8}. In order to obtain more accurate prediction of overlay offset at T_{A,4}, out-of-date D_{B,8} is not used to make the prediction.

When the time interval between T_{A,3} and T_{B,8} exceeds the second threshold, other suitable overlay information is searched. In some embodiments, previous overlay information, such as D_{A,2}, can be retrieved. The overlay information D_{A,2} corresponds to a wafer lot of product A processed at T_{A,2}. An operation record of product B corresponding to a wafer lot processed at a time near the T_{A,2} is retrieved. In some embodiments, D_{B,4} is processed at time T_{B,4}, a process time most proximate to T_{A,2}. Step S48 is performed to check whether the interval between T_{A,2} and T_{B,4} is less than a predetermined threshold.

In order to obtain more accurate prediction of overlay offset at T_{A,4}, overlay offsets for a plurality of process runs are checked to eliminate extreme values of overlay offsets from overlay information D_{B,8} (step S48). The checking process can be performed using 3-sigma method or other statistical methods.

In step S491, an overlay offset for L₁₀ is determined. When overlay information D_{A,3}, D_{B,10}, and D_{B,8} meet the aforementioned time threshold criteria and statistical criteria, overlay offsets O_{A,3}, O_{B,10}, and O_{B,8} comprised in the D_{A,3}, D_{B,10}, and D_{B,8} are retrieved, and overlay offset for L₁₀ is determined accordingly. The overlay offset for L₁₀ (O_{A,4}) can be determined using the following equation:
O_{A,4}=(O_{B,10}−O_{B,8})+O_{A,3} (1)

In step S495, a lithography process is performed according to overlay offset for L₁₀ (O_{A,4}).

In some embodiments, overlay information of product B corresponding to wafer lot L₉ is used to determine overlay offset of wafer lot L₁₀. For an exposure tool processing highly variable products, processing time for wafer lots consecutively processed by the exposure tool may be substantially close. For example, processing time for wafer lots L₁₀, L₉, L₈, and L₇ may be accomplished within three days, which is shorter than the first threshold, i.e. five days. In this case, overlay information of products pertaining to L₉, L₈, and L₇ can be used to determine overlay offset of wafer lot L₁₀.

For example, in step S48, if the time interval between T_{A,3} and T_{B,8} exceeds the second threshold, overlay information of products pertaining to wafer lot L₈ can be used to determine overlay offset of wafer lot L₁₀. The overlay information corresponding to wafer lot L₈ is processed as in step S45 through step S48.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

These disclosed systems and methods are capable of determine lithography overlay offsets. By determining lithography overlay offsets, some embodiments of systems and methods perform lithography processes achieving higher overlay accuracy. Additionally, the overlay offsets are determined according to previous overlay offsets without using a test wafer, which reduces process cost effectively.

What is claimed is:

1. A system of determining lithography overlay offsets, comprising:
a first database storing operation records of lots processed consecutively by an exposure tool, wherein each lot corresponds to a layer of a product, and the operation records pertain to a subsequent lot Lₖ and a previous lot Lₖ₋₁ corresponding to products A and B, respectively;
a second database storing overlay information of lots corresponding to the products A and B, wherein the overlay information comprises overlay information D_{A,X} and D_{B,Y} corresponding to X^{th} and Y^{th} records of the products A and B; and
a controller determining an overlay offset corresponding to the lot Lₖ according to the overlay information D_{A,X} and D_{B,Y}.

2. The system of claim 1, wherein the overlay information D_{A,X} and D_{B,Y} comprise overlay offsets and processing time corresponding to lots of the products A and B processed by the exposure tool, respectively.

3. The system of claim 2, wherein the overlay information D_{A,X} and D_{B,Y} comprise information of product names, a processed layer, an utilized mask, and an exposure tool name corresponding to the lots Lₖ and Lₖ₋₁.

4. The system of claim 1, wherein the lot Lₖ is scheduled for processing by the exposure tool at time T_{A,m+1}, and the lot Lₖ₋₁ is processed at time T_{B,n}, wherein an interval between T_{A,m+1} and T_{B,n} is less than a first threshold.

5. The system of claim 4, wherein the controller retrieves overlay information D_{A,m} corresponding to a latest lot of the product A processed at T_{A,m} by the exposure tool, and retrieves overlay information of the product B processed at time T_{B,n-j} close to T_{A,m} by the exposure tool, with an interval between T_{B,n-j} and T_{A,m} smaller than a second threshold.

6. The system of claim 5, wherein the controller retrieves overlay offsets comprised in the overlay information D_{A,m}, D_{B,n}, and D_{B,n-j}, and determines the overlay offset corresponding to the lot Lₖ accordingly.

7. A method of performing a lithography process, comprising:
providing operation records of lots processed consecutively by an exposure tool, wherein each lot corresponds to a layer of a product, and the operation records pertain to a subsequent lot Lₖ and a previous lot Lₖ₋₁ corresponding to products A and B, respectively;
providing overlay information of lots corresponding to the products A and B, wherein the overlay information comprises overlay information D_{A,X} and D_{B,Y} corresponding to X^{th} and Y^{th} records of the products A and B; and
determining an overlay offset corresponding to the lot Lₖ according to the overlay information D_{A,X} and D_{B,Y}.

8. The method of claim 7, wherein the overlay information D_{A,X} and D_{B,Y} comprise overlay offsets and processing time corresponding to lots of the products A and B processed by the exposure tool, respectively.

9. The method of claim 8, wherein the overlay information D_{A,X} and D_{B,Y} comprise information of product names, a processed layer, an utilized mask, and an exposure tool name corresponding to the lots Lₖ and Lₖ₋₁.

10. The method of claim 7, wherein the lot Lₖ₋₁ is processed at time T_{B,n}, the lot Lₖ for processing by the exposure tool is scheduled at time T_{A,m+1}, and the method further comprises determining whether an interval between T_{A,m+1} and T_{B,n} is less than a first threshold.

11. The method of claim 10, further comprising:
retrieving overlay information D_{A,m} corresponding to a latest lot of the product A processed at T_{A,m} by the exposure tool;
retrieving overlay information of the product B processed at time T_{B,n-j} close to T_{A,m} by the exposure tool; and
determining whether an interval between T_{B,n-j} and T_{A,m} is smaller than a second threshold.

12. The method of claim 11, further comprising retrieving overlay offsets comprised in the overlay information D_{A,m}, D_{B,n}, and D_{B,n-j}, and determining the overlay offset corresponding to the lot Lₖ accordingly.

13. The method of claim 7, further comprising providing the lot Lₖ before providing the operation records.

14. The method of claim 7, further comprising processing the lot Lₖ according to the determined overlay offset.

15. A semiconductor device processed by the method of claim 14.

16. A method of performing a lithography process, comprising:
providing a first database storing operation records of lots processed consecutively by an exposure tool, wherein each lot corresponds to a layer of a product, and the operation records pertain to a subsequent lot Lₖ and a previous lot Lₖ₋₁ corresponding to products A and B, respectively, wherein the lot Lₖ is scheduled to be processed by the exposure tool at time T_{A,m+1}, and the lot Lₖ₋₁ is processed at time T_{B,n}, with an interval between T_{A,m+1} and T_{B,n} less than a first threshold;
providing overlay information of lots corresponding to the products A and B, wherein the overlay information comprises overlay information D_{A,X} and D_{B,Y} corresponding to X^{th} and Y^{th} records of the products A and B;
retrieving overlay information D_{A,m} corresponding to a latest lot of the product A processed at T_{A,m} by the exposure tool;
retrieving overlay information of the product B processed at time T_{B,n-j} close to T_{A,m} by the exposure tool, and determining whether an interval between T_{B,n-j} and T_{A,m} is smaller than a second threshold;
retrieving overlay offsets comprised in the overlay information D_{A,m}, D_{B,n}, and D_{B,n-j}, and determining an overlay offset corresponding to the lot Lₖ accordingly; and
processing the lot Lₖ according to the determined overlay offset.

17. The method of claim 16, wherein the overlay information D_{A,X} and D_{B,Y} comprise overlay offsets and processing time corresponding to lots of the products A and B processed by the exposure tool, respectively.

18. The method of claim 16, wherein the overlay information D_{A,X} and D_{B,Y} comprise information of product names, a processed layer, an utilized mask, and an exposure tool name corresponding to the lots Lₖ and Lₖ₋₁.

19. The method of claim 16, further comprising providing the lot Lₖ before processing the lot Lₖ according to the determined overlay offset.
